(19) United States
(12) Patent Application Publication
(10) Pub. No.: US 2013/0033884 A1
(43) Pub. Date: Feb. 7, 2013

(54) LIGHT GUIDE LENS AND BICYCLE HEADLIGHT HAVING THE SAME

(71) Applicants: Wei-Yu LO, Taichung City (TW); Poche LEE, Taichung County (TW); Kuo-Wen CHANG, Taichung City (TW)

(72) Inventors: Wei-Yu LO, Taichung City (TW); Poche LEE, Taichung County (TW); Kuo-Wen CHANG, Taichung City (TW)

(73) Assignee: Genius Electronic Optical Co., Ltd., Taichung City (TW)

(21) Appl. No.: 13/556,409

(22) Filed: Jul. 24, 2012

(30) Foreign Application Priority Data
Aug. 1, 2011 (TW) 100127267

(51) Int. Cl. F21V 5/04; B62J 6/02

(52) U.S. Cl. 362/475; 362/338

(57) ABSTRACT

A light guide lens includes: an outer surrounding surface that extends between a front surface disposed at an optical axis, and a rear end formed with a recess that has an end surface disposed at the optical axis, and an inner surrounding surface extending rearward from a periphery of the end surface. The outer surrounding surface diverges forwardly along the optical axis, and includes first and second pairs of curved surface parts, the first pair being disposed mutually asymmetrical on opposite sides of an imaginary plane, the second pair being disposed mutually symmetrical on opposite sides of another imaginary plane and extending between the first pair. The end surface includes a third pair of curved surface parts disposed mutually asymmetrical on opposite sides of yet another imaginary plane.

### CROSS-REFERENCE TO RELATED APPLICATION

This application claims priority of Taiwanese Application No. 100127267, filed on Aug. 1, 2011.

### BACKGROUND OF THE INVENTION

1. Field of the Invention

The present invention relates to a lens, more particularly to a light guide lens and a bicycle headlight having the same.

2. Description of the Related Art

A conventional light guide lens of a bicycle headlight, such as one disclosed in U.S. Pat. No. 5,757,557, generally adopts a symmetric light output design, in which an inner sidewall is rotationally symmetric about an optical axis such that light projected through the light guide lens has an illumination distribution symmetric about the optical axis. Nevertheless, several countries (e.g., Germany) have introduced stricter road safety regulations by which light projected through light guide lenses of bicycle headlights must satisfy certain distributions.

Referring to FIG. 1, according to the German road traffic licensing regulations (StVZO §67), in a measurement configuration where a light source (e.g., a bulb) of the bicycle headlight is powered by a power source of 6 W/12V, and where the bicycle headlight is disposed such that a central axis of the bicycle headlight extends perpendicular to a measurement plane 1 that is 10 meters away from the bicycle headlight and intersects with measurement point “HV” on the measurement plane 1, light projected from the bicycle headlight through the light guide lens must satisfy the following requirements:

1) an illumination intensity of the light at measurement point “HV” must exceed 20 lux;

2) a maximum illumination intensity of the light over the measurement plane 1 must not exceed 1.2 times the illumination intensity of the light beam at measurement point “HV”;

3) illumination intensity of the light at measurement points “L1”, “R1”, and “2” must exceed 0.5 times the maximum illumination intensity, measurement points “L1”, “R1”, and “2” being disposed at 4° to the left of measurement point “HV”, 4° to the right of measurement point “HV”, and 1.5° below measurement point “HV”, respectively;

4) an illumination intensity of the light in a lower vertical region between measurement points “2” and “3” must exceed 2.5 lux, measurement point “3” being disposed at 5° below measurement point “HV”;

5) an illumination intensity of the light in a lower horizontal region extending between measurement points “L5” and “R5” across measurement points “L4” and “R4” must exceed 2 lux, measurement point “L4” being disposed at 4° to the left of measurement point “3”, measurement point “L5” being disposed at 4° to the left of measurement point “L4”, measurement point “R4” being disposed at 4° to the right of measurement point “3”, measurement point “R5” being disposed at 4° to the right of measurement point “R4”; and

6) an illumination intensity of the light in an upper horizontal region 110 at 3.4° above measurement point “HV” must not exceed 2 lux.

It can be understood from the above requirements that illumination intensity of the light as measured on the measurement plane 1 must be highest in the center, gradually decrease in a vertical direction from the center with a non-axially symmetrical distribution, and gradually decrease in a horizontal direction from the center with a symmetrical distribution. In view of the above, conventional bicycle headlights that output light with symmetrical illumination distributions no longer satisfy the current regulations. Although the conventional bicycle headlights may be modified with such as reflectors, light-emitting efficiencies of the bicycle headlights may as a result be compromised.

### SUMMARY OF THE INVENTION

Therefore, an object of the present invention is to provide a light guide lens capable of achieving an asymmetrical illumination distribution.

Accordingly, a light guide lens of the present invention includes:

a convex front surface disposed such that said convex front surface is centered on an optical axis of said light guide lens;

a rear end formed with a recess that has a convex innermost surface centered on the optical axis and an inner surrounding surface around the innermost surface; and

an outer surrounding surface extending between the front surface and the rear end, and diverging forwardly along the optical axis, the outer surrounding surface including
a first curved surface part and a second curved surface part disposed respectively on opposite sides of a first imaginary plane and being asymmetrical relative to each other with respect to the first imaginary plane, the optical axis being disposed on the first imaginary plane, and
a third curved surface part and a fourth curved surface part disposed respectively on opposite sides of a second imaginary plane, extending between the first curved surface part and the second curved surface part, and being symmetrical relative to each other with respect to the second imaginary plane, the optical axis being disposed on the second imaginary plane;

the convex innermost surface including
a fifth curved surface part and a sixth curved surface part disposed respectively on opposite sides of a third imaginary plane and being asymmetrical relative to each other with respect to the third imaginary plane, the optical axis being disposed on the third imaginary plane.

Another object of the present invention is to provide a bicycle headlight capable of outputting light with an asymmetrical illumination distribution.

Accordingly, a bicycle headlight of the present invention includes a housing body, and the aforesaid light guide lens.

### BRIEF DESCRIPTION OF THE DRAWINGS

Other features and advantages of the present invention will become apparent in the following detailed description of the preferred embodiments with reference to the accompanying drawings, of which:

FIG. 1 shows a measurement plane for measuring illumination distribution of a bicycle headlight;

FIG. 2 shows the first preferred embodiment of a bicycle headlight according to the present invention;

FIG. 3 shows a longitudinal cross-sectional view of a light guide lens of the bicycle headlight of the first preferred embodiment;

FIG. 4 shows a back view of the light guide lens of the bicycle headlight of the first preferred embodiment;

FIGS. 5a to 5c show values of parameters of an optical equation corresponding to a front surface, curved surface parts of an outer surrounding surface, and curved surface parts of a innermost surface of a rear end of the light guide lens of the bicycle headlight of the first preferred embodiment;

FIG. 6 shows a measured illumination distribution of the bicycle headlight of the first preferred embodiment;

FIG. 7 shows a longitudinal cross-sectional view of a light guide lens of the second preferred embodiment of a bicycle headlight according to the present invention;

FIG. 8 shows a back view of the light guide lens of the bicycle headlight of the second preferred embodiment;

FIG. 9 shows a measured illumination distribution of the bicycle headlight of the second preferred embodiment;

FIG. 10 shows values of the parameters of the optical equation corresponding to regions of a first surface part and other curved surface parts of an outer surrounding surface of the light guide lens of the bicycle headlight of the second preferred embodiment;

FIG. 11 shows a longitudinal cross-sectional view of a light guide lens of the third preferred embodiment of a bicycle headlight according to the present invention;

FIG. 12 shows a back view of the light guide lens of the bicycle headlight of the third preferred embodiment;

FIG. 13 shows a measured illumination distribution of the bicycle headlight of the third preferred embodiment;

FIG. 14 shows values of the parameters of the optical equation corresponding to regions of a second curved surface part of an outer surrounding surface of the light guide lens of the bicycle headlight of the third preferred embodiment;

FIG. 15 shows a longitudinal cross-sectional view of a light guide lens of the fourth preferred embodiment of a bicycle headlight according to the present invention;

FIG. 16 shows a back view of the light guide lens of the bicycle headlight of the fourth preferred embodiment;

FIG. 17 shows a measured illumination distribution of the bicycle headlight of the fourth preferred embodiment;

FIG. 18 shows values of the parameters of the optical equation corresponding to regions of each of first and second curved surface parts of an outer surrounding surface of the light guide lens of the bicycle headlight of the fourth preferred embodiment;

FIG. 19 shows a back view of the light guide lens of the bicycle headlight of the fifth preferred embodiment;

FIG. 20 shows a measured illumination distribution of the bicycle headlight of the fifth preferred embodiment;

FIG. 21 shows values of the parameters of the optical equation corresponding to regions of each of third and fourth curved surface parts of an outer surrounding surface of the light guide lens of the bicycle headlight of the fifth preferred embodiment;

FIG. 22 shows a back view of the light guide lens of the bicycle headlight of the sixth preferred embodiment;

FIG. 23 shows an overlay of the measurement plane depicted in FIG. 1 over a measured illumination distribution of the bicycle headlight of the sixth preferred embodiment;

FIG. 24 shows values of the parameters of the optical equation corresponding to first, second, third, and fourth surface parts of an outer surrounding surface of the light guide lens of the bicycle headlight of the sixth preferred embodiment;

FIG. 25 shows values of the parameters of the optical equation corresponding to fifth and sixth surface parts of the outer surrounding surface of the light guide lens of the bicycle headlight of the sixth preferred embodiment;

FIG. 26 shows a longitudinal cross-sectional view of a light guide lens of the seventh preferred embodiment of a bicycle headlight according to the present invention;

FIG. 27 shows a back view of the light guide lens of the bicycle headlight of the seventh preferred embodiment;

FIG. 28 shows a measured illumination distribution of the bicycle headlight of the seventh preferred embodiment;

FIG. 29 shows values of the parameters of the optical equation corresponding to regions of a second curved surface part of an outer surrounding surface of the light guide lens of the bicycle headlight of the seventh preferred embodiment;

FIG. 30 shows a back view of the light guide lens of the bicycle headlight of the eighth preferred embodiment;

FIG. 31 shows a measured illumination distribution of the bicycle headlight of the eighth preferred embodiment; and

FIG. 32 shows values of the parameters of the optical equation corresponding to regions of third and fourth curved surface parts of an outer surrounding surface of the light guide lens of the bicycle headlight of the eighth preferred embodiment.

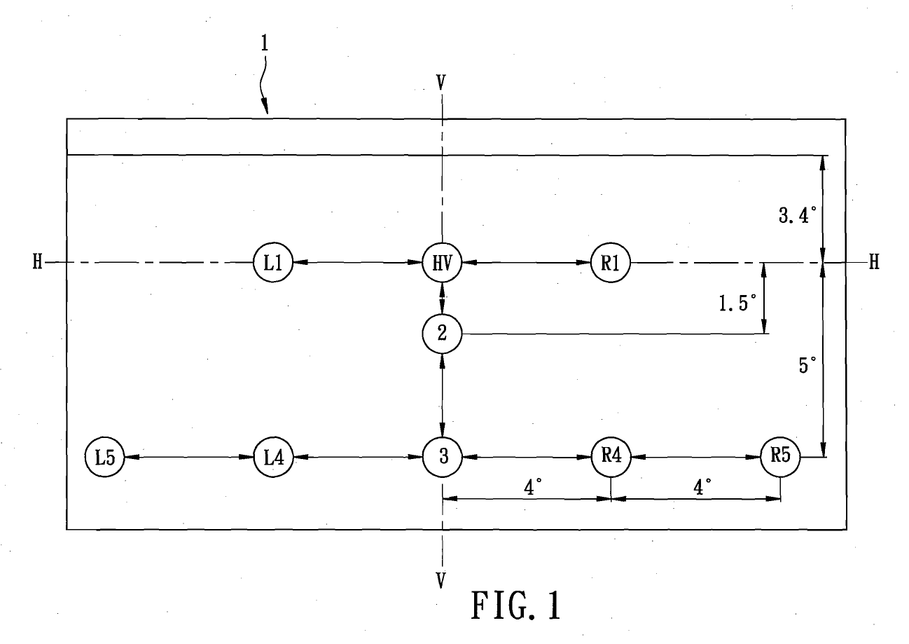

### DETAILED DESCRIPTION OF THE PREFERRED EMBODIMENTS

Before the present invention is described in greater detail, it should be noted that like elements are denoted by the same reference numerals throughout the disclosure.

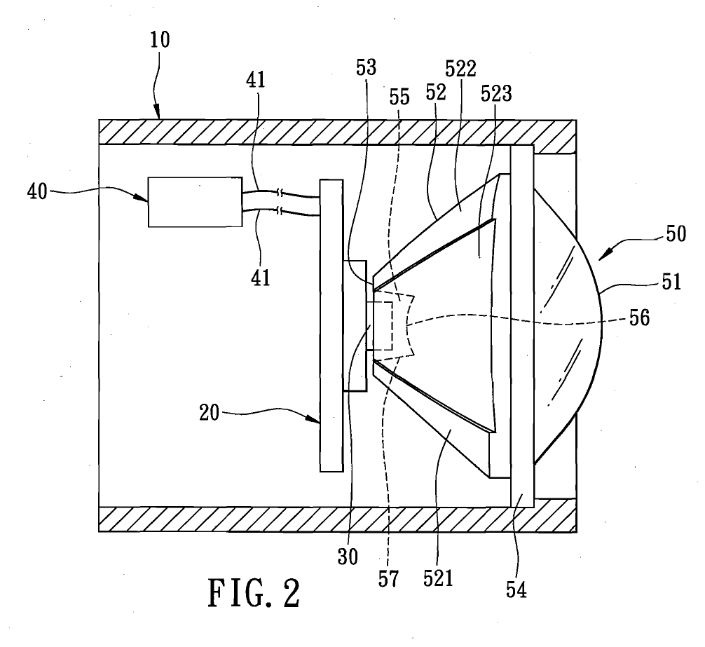

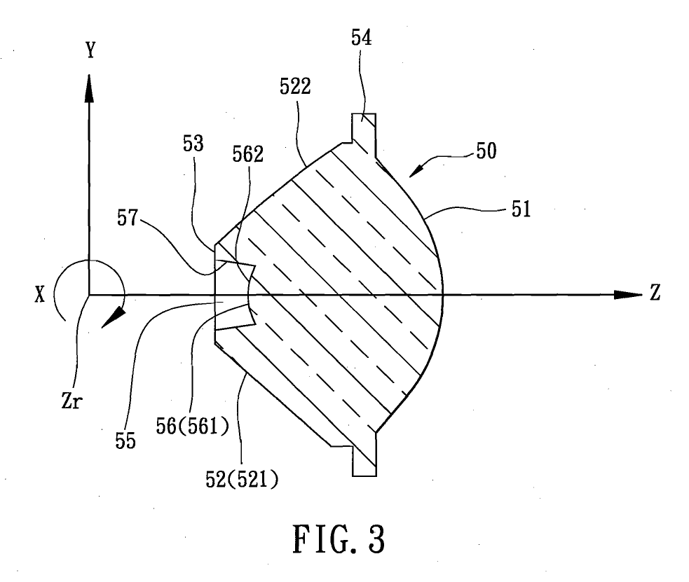

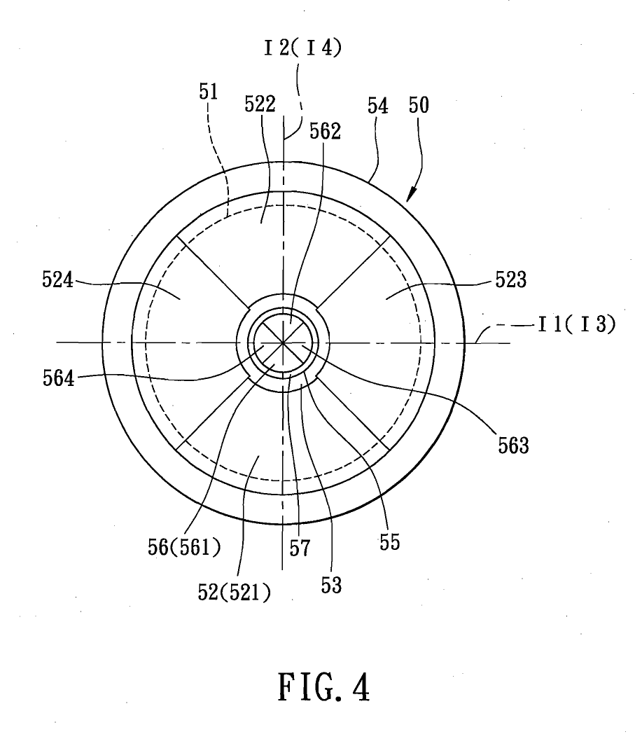

Referring to FIGS. 2 to 4, the first preferred embodiment of bicycle headlight, according to the present invention, includes a housing body 10, a circuit board 20, a light source 30, a power source 40, and a light guide lens 50. The housing body 10 is formed with a receiving space for receiving the circuit board 20, the light source 30, the power source 40, and the light guide lens 50. In this embodiment, the light source 30 is a light-emitting diode (LED) lamp powered by the power source 40 (e.g., a battery) via a pair of conductive wires 41 and the circuit board 20.

The light guide lens 50 is substantially disposed in the housing body 10, and has a front surface 51, an outer surrounding surface 52, and a rear end 53. The front surface 51 is a convex surface centered on an optical axis (Z), which coincides with a junction of mutually perpendicular first and second imaginary planes (I1, I2), i.e., the optical axis (Z) being disposed on the first and second imaginary planes (I1, I2). The front surface 51 is asymmetrical with respect to the first imaginary plane (I1), and is further symmetrical with respect to the second imaginary plane (I2).

The outer surrounding surface 52 extends between the front surface 51 and the rear end 53, diverges forwardly along the optical axis (Z), and includes: first and second curved surface parts 521, 522 disposed respectively on opposite sides of the first imaginary plane (I1), and asymmetrical relative to each other with respect to the first imaginary plane (I1); and third and fourth curved surface parts 523, 524 disposed respectively on opposite sides of the second imaginary plane (I2), extending between the first and second curved surface parts 521, 522, and symmetrical relative to each other with respect to the second imaginary plane (I2). Each of the third and fourth curved surface parts 523, 524 interconnects the first and second curved surface parts 521,522 at a corresponding side of the first and second curved surface parts 521, 522. In this embodiment, each of the first, second, third, and fourth curved surface parts 521-524 subtends an angle of 90 degrees with respect to the optical axis (Z). The bicycle headlight is preferably oriented such that the first, second, third, and fourth curved surface parts 521-524 are at lower, upper, right, and left positions, respectively.

In this embodiment, the light guide lens 50 further has an annular flange 54 disposed at a junction of the front surface 51 and the outer surrounding surface 52 for securing the light guide lens 50 to the housing body 10. In this embodiment, the light source 30 is disposed corresponding to the recess 55 and is extended thereinto. It is worth noting that, although the annular flange 54 may implemented to improve aesthetics of the light guide lens 50, the flange 54 may optionally be omitted during manufacture to thereby reduce cost. The front surface 51 and the outer surrounding surface 52 are connected directly to each other if the flange 54 is omitted.

The rear end 53 is formed with a recess 55 for receiving the light source 30. In particular, the light source 30 has a portion extending into the recess 55 for providing illumination. The recess 55 in the rear end 53 has a convex innermost surface 56 centered on the optical axis (Z), and an inner surrounding surface 57 around the innermost surface 56. The innermost surface 56 has fifth, sixth, seventh, and eighth curved surface parts 561-564 arranged to correspond to the first, second, third, and fourth curved surface parts 521-524 of the outer surrounding surface 52, respectively.

Specifically, the fifth and sixth curved surface parts 561, 562 are disposed respectively on opposite sides of a third imaginary plane (I3) and are disposed asymmetrical to each other with respect to the third imaginary plane (I3). The seventh and eighth curved surface parts 563, 564 are disposed respectively on opposite sides of a fourth imaginary plane (I4), extend between the fifth and sixth curved surface parts 563, 564, and are disposed symmetrical relative to each other with respect to the fourth imaginary plane (I4). Each of the seventh and eighth curved surface parts 563, 564 interconnects the fifth and sixth curved surface parts 561,562 at a corresponding side of the fifth and sixth curved surface parts 561, 562. Each of the fifth, sixth, seventh, and eighth curved surface parts 561-564 subtends an angle of 90 degrees with respect to the optical axis (Z).

In this embodiment, the third and fourth imaginary planes (I3, I4) coincide with the first and second imaginary planes (I1, I2), respectively, and hence a junction of the third and fourth imaginary planes (I3, I4) coincides with the optical axis (Z). In the abovementioned orientation of the bicycle headlight, the fifth, sixth, seventh, and eighth curved surface parts 561-564 correspond to the lower, upper, right, and left positions, respectively.

The front surface 51, the outer surrounding surface 52, and the innermost surface 56 are surfaces with curvatures that may be defined by the optical equation of

$$z - {z}_{0} = \frac{\frac{1}{{r}_{x}} {x}^{2} + \frac{1}{{r}_{y}} {y}^{2}}{1 + \sqrt{1 - \frac{( 1 + {k}_{x} )}{{r}_{x}^{2}} {x}^{2} - \frac{( 1 + {k}_{y} )}{{r}_{y}^{2}} {y}^{2}}} + {\sum }_{n = 2}^{10} {{A}_{2 n} [ ( 1 - {B}_{2 n} ) {x}^{2} + ( 1 + {B}_{2 n} ) {y}^{2} ]}^{n}$$

where ‘x’ represents a coordinate in an X-axis perpendicular to the optical axis (Z), ‘y’ represents a coordinate in a Y-axis perpendicular to the optical axis (Z) and the X-axis, ‘z’ represents a coordinate in a Z-axis corresponding to the optical axis (Z), ‘z₀’ represents a distance from the apex of the respective surface to a reference point ‘Zr’ in the Z-axis, ‘rₓ’ represents a curvature radius at the X-axis, ‘kₓ’ represents a conic constant at the X-axis, ‘r_{y}’ represents a curvature radius at the Y-axis, ‘k_{y}’ represents a conic constant at the Y-axis, ‘A₂ₙ’ represents a symmetry constant, and ‘B₂ₙ’ represents an asymmetry constant.

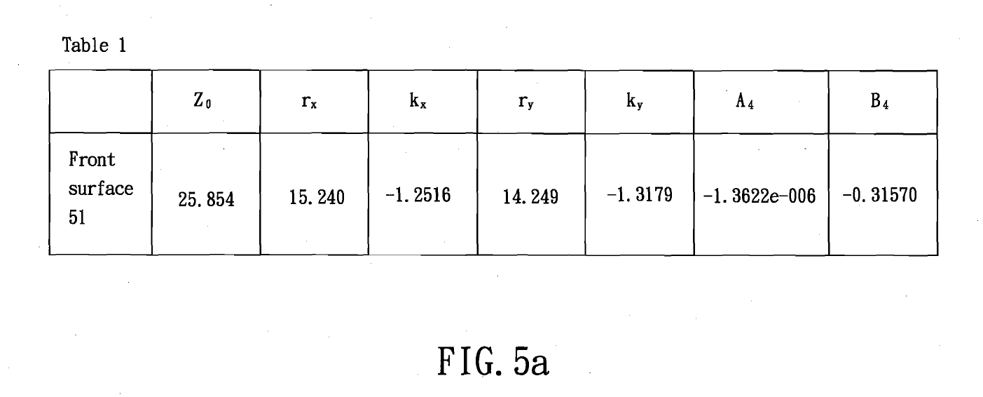

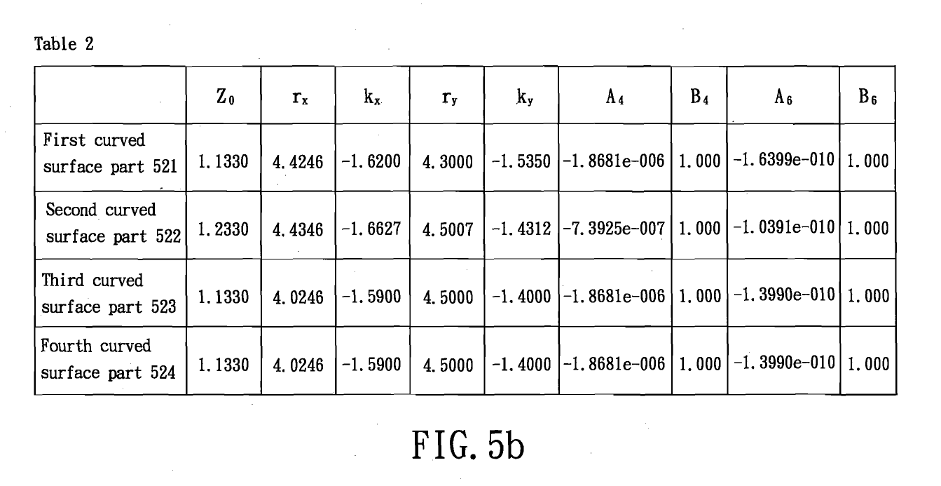

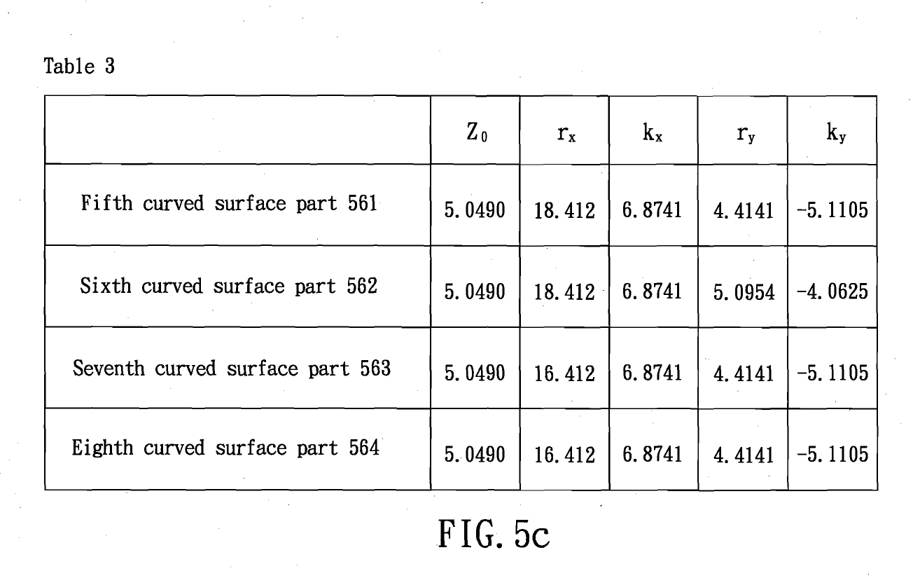

Table 1 (see FIG. 5a) shows values of the aforesaid parameters corresponding to the front surface 51. Table 2 (see FIG. 5b) shows values of the aforesaid parameters corresponding to the first, second, third, and fourth curved surface parts 521-524 of the outer surrounding surface 52. Table 3 (see FIG. 5c) shows values of the aforesaid parameters corresponding to the fifth, sixth, seventh, and eighth curved surface parts 561-564 of the innermost surface 56.

Since the first and second curved surface parts 521, 522 must be asymmetrical relative to each other with respect to the first imaginary plane (I1), at least one value of the parameters of ‘z₀’, rₓ’, ‘kₓ’, ‘r_{y}’, ‘k_{y}’, ‘A₂ₙ’, and ‘B₂ₙ’ of the first curved surface part 521 must be different from those of the second curved surface part 522. On the other hand, since the third and fourth curved surface parts 523, 524 are symmetrical relative to each other with respect to the second imaginary plane (I2), values of the parameters of ‘z₀’, rₓ’, ‘kₓ’, ‘r_{y}’, ‘k_{y}’, ‘A₂ₙ’, and ‘B₂ₙ’ of the third curved surface part 523 must be identical to those of the fourth curved surface part 524.

Similarly, since the fifth and sixth curved surface parts 561, 562 are asymmetrical relative to each other with respect to the third imaginary plane (I3) (i.e., the first imaginary plane (I1)), at least one value of the parameters of ‘z₀’, rₓ’, ‘kₓ’, ‘r_{y}’, ‘k_{y}’, ‘A₂ₙ’, and ‘B₂ₙ’ of the fifth curved surface part 561 must be different from those of the sixth curved surface part 562. Since the seventh and eighth curved surface parts 563, 564 are symmetrical relative to each other with respect to the fourth imaginary plane (I4) (i.e., the second imaginary plane (I2)), values of the parameters of ‘z₀’, rₓ’, ‘kₓ’, ‘r_{y}’, ‘k_{y}’, ‘A₂ₙ’, and B₂ₙ of the seventh curved surface part 563 must be identical to those of the eighth curved surface part 564.

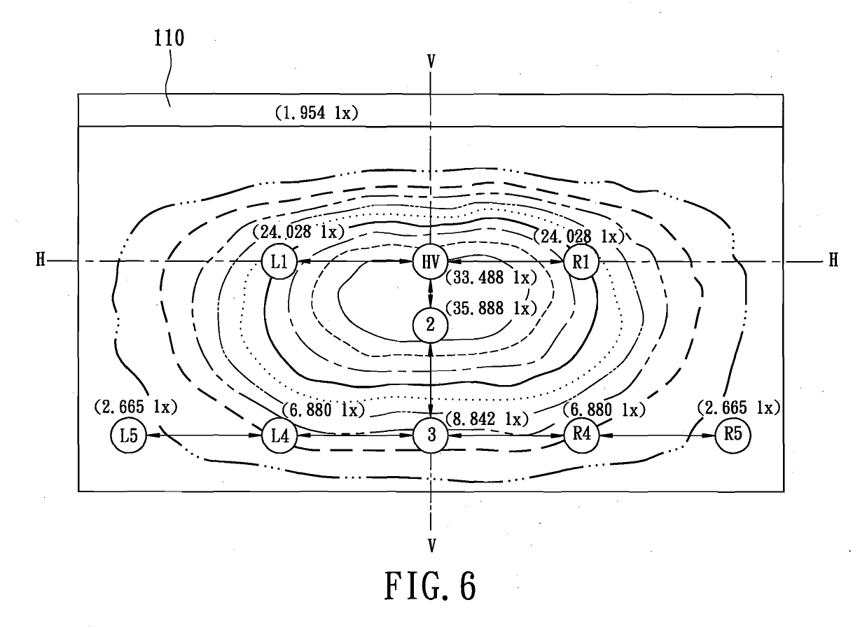

FIG. 6 shows a measurement of illumination distribution of the light guide lens 50 (i.e., the abovementioned bicycle headlight) of the first preferred embodiment obtained in accordance with the German road traffic licensing regulations (StVZO§67).

Light refracted by the inner surrounding surface 57, reflected by the first curved surface part 521, and refracted by the front surface 51 forms a first light output. Light refracted by the inner surrounding surface 57, reflected by the second curved surface part 522, and refracted by the front surface 51 forms a second light output asymmetrical relative to the first light output with respect to the first imaginary plane (I1).

Light refracted by the fifth curved surface part 561 and the front surface 51 forms a third light output. Light refracted by the sixth curved surface part 562 and the front surface 51 forms a fourth light output asymmetrical relative to the third light output with respect to the third imaginary plane (I3) (i.e., the first imaginary plane (I1)).

Light refracted by the inner surrounding surface 57, reflected by the third curved surface part 523, and refracted by the front surface 51 forms a fifth light output. Light refracted by the inner surrounding surface 57, reflected by the fourth curved surface part 524, and refracted by the front surface 51 forms a sixth light output symmetrical relative to the fifth light output with respect to the second imaginary plane (I2).

Light refracted by the seventh curved surface part 563 and the front surface 51 forms a seventh light output. Light refracted by the eighth curved surface part 564 and the front surface 51 forms an eighth light output symmetrical relative to the seventh light output with respect to the fourth imaginary plane (I4) (i.e., the second imaginary plane (I2)).

In the first preferred embodiment, the illumination intensities at measurement points “HV”, “L1”, “R1”, “2”, “3”, “L4”, “R4”, “L5”, and “R5” are 33.488 lux, 24.028 lux, 24.028 lux, 35.888 lux, 8.842 lux, 6.88 lux, 6.88 lux, 2.665 lux, and 2.665 lux, respectively. The illumination intensity in the upper horizontal region 110 is 1.954 lux. Thus, the light guide lens 50 of the first preferred embodiment of the present invention complies with the German road traffic licensing regulations.

It is apparent from the description hereinabove that the bicycle headlight of the present invention is able to achieve a distribution in which intensity of light fades symmetrically and asymmetrically away from the center in horizontal and vertical directions, respectively, such that the bicycle headlight of the present invention complies with the German road traffic licensing regulations (StVZO§67).

To reiterate, since the first and second curved surface parts 521, 522 are asymmetrical relative to each other with respect to the first imaginary plane (I1), and the fifth and sixth surface parts 561, 562 are asymmetrical relative to each other with respect to the third imaginary plane (I1), light that passes through either the inner surrounding surface 57 or the innermost surface 56 of the recess 55 is asymmetrical about the first imaginary plane (I1) and symmetrical about the second imaginary plane (I2). Therefore, the bicycle headlight of the present invention is suitable for use in countries with road safety regulations similar to the German road traffic licensing regulations (StVZO §67). Further, since the bicycle headlight does not need to be modified with such as reflectors, light-emitting efficiencies of the bicycle headlight is relatively high and production cost of the same is relatively low.

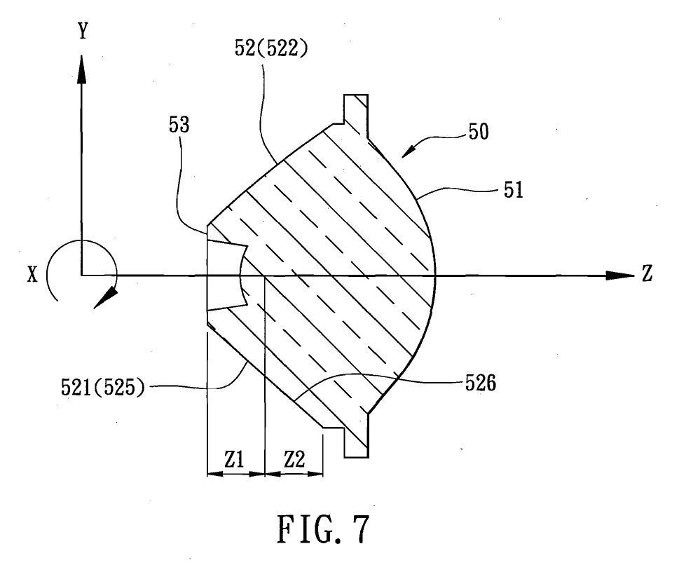

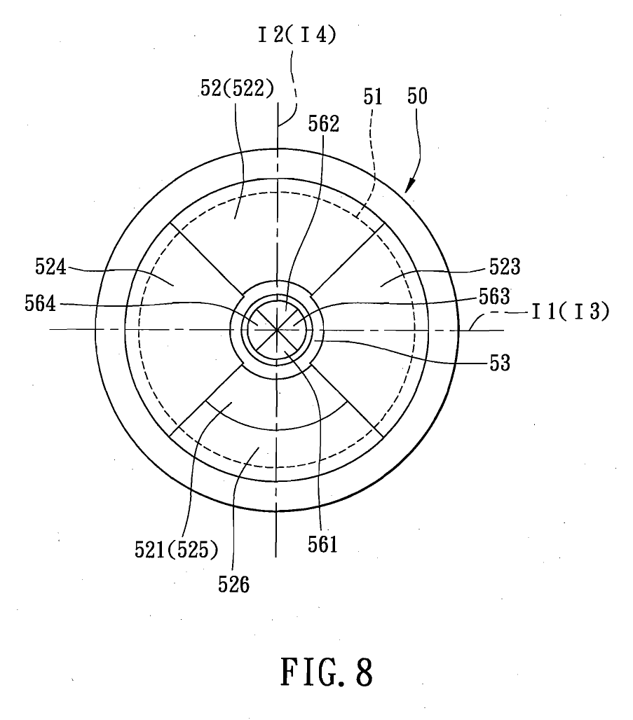

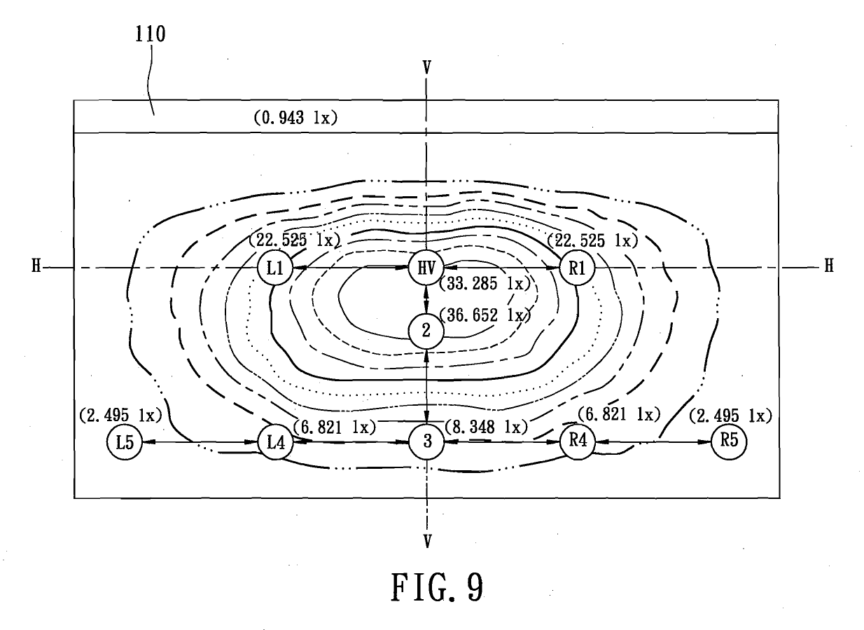

Referring to FIGS. 7 to 9, the difference between the first and second preferred embodiments resides in that, in the second preferred embodiment, the first curved surface part 521 of the outer surrounding surface 52 is divided into front and rear regions 526, 525 which are proximate to the front surface 51 and the rear end 53, respectively. Projection of the rear region 525 on the optical axis (Z) (marked by “Z1”) is identical in length to projection of the front region 526 on the optical axis (Z) (marked by “Z2”).

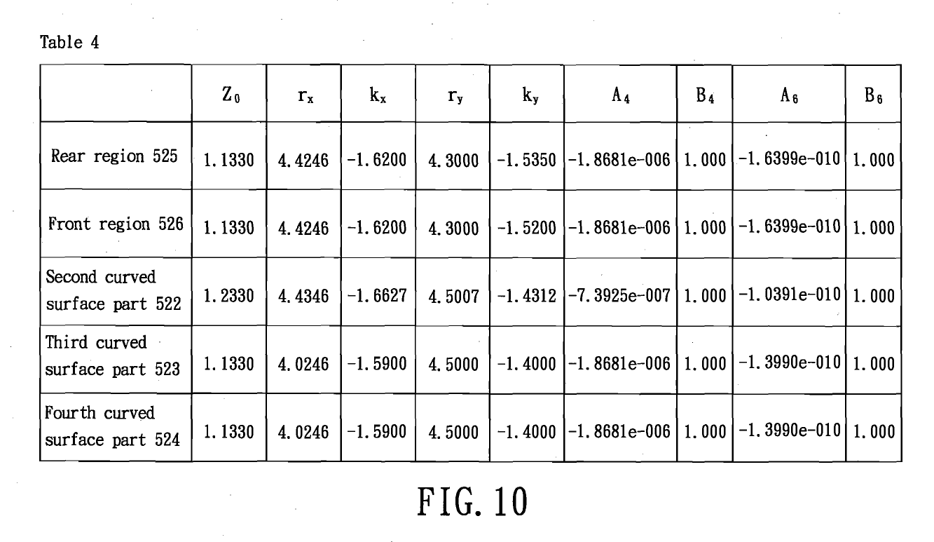

Referring to Table 4 (see FIG. 10), the front and rear regions 526, 525 may also be defined by the aforementioned optical equation.

In the second preferred embodiment, the illumination intensities at measurement points “HV”, “L1”, “R1”, “2”, “3”, “L4”, “R4”, “L5”, and “R5” are 33.285 lux, 22.525 lux, 22.525 lux, 36.652 lux, 8.348 lux, 6.821 lux, 6.821 lux, 2.495 lux, and 2.495 lux, respectively. The illumination intensity in the upper horizontal region 110 is 0.943 lux. Thus, the light guide lens 50 of the second preferred embodiment of the present invention complies with the German road traffic licensing regulations, and is capable of achieving a low illumination intensity in the upper horizontal region 110 relative to the first preferred embodiment.

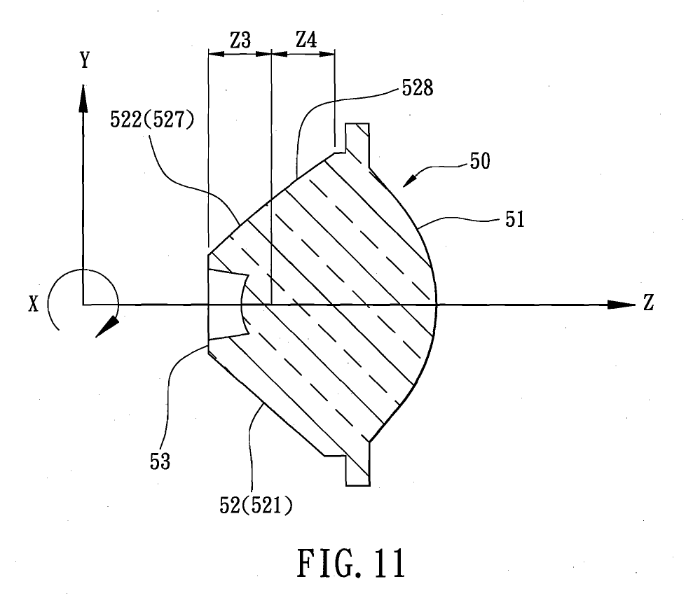

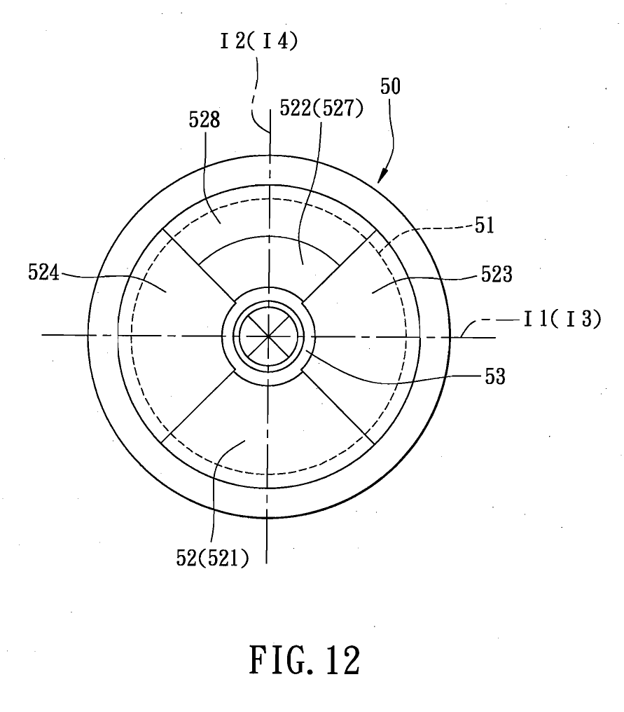

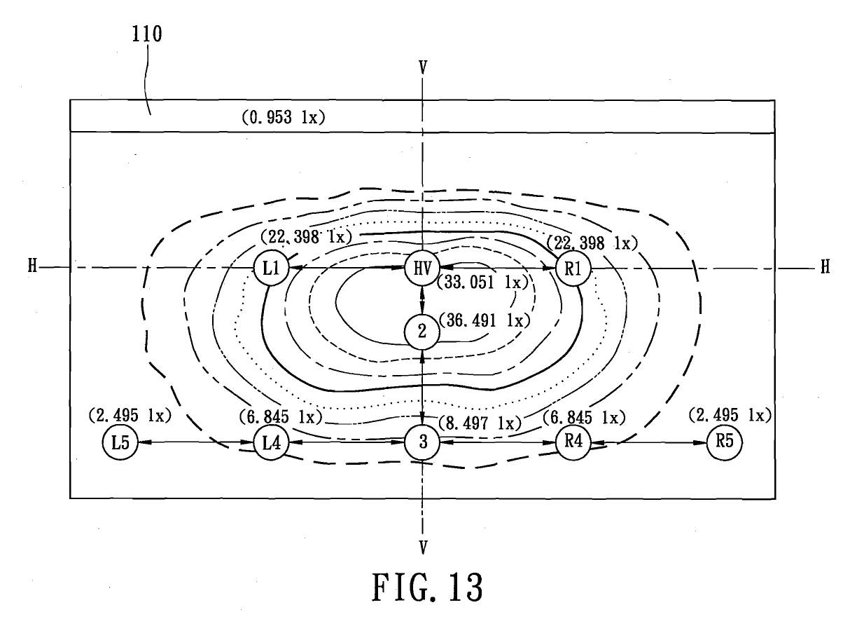

Referring to FIGS. 11 to 13, the difference between the first and third preferred embodiments resides in that, in the third preferred embodiment, the second curved surface part 522 of the outer surrounding surface 52 is divided into front and rear regions 528, 527 arranged along the optical axis (Z), and proximate to the front surface 51 and the rear end 53, respectively. Projection of the rear region 527 on the optical axis (Z) (marked by “Z3”) is identical in length to projection of the front region 528 on the optical axis (Z) (marked by “Z4”).

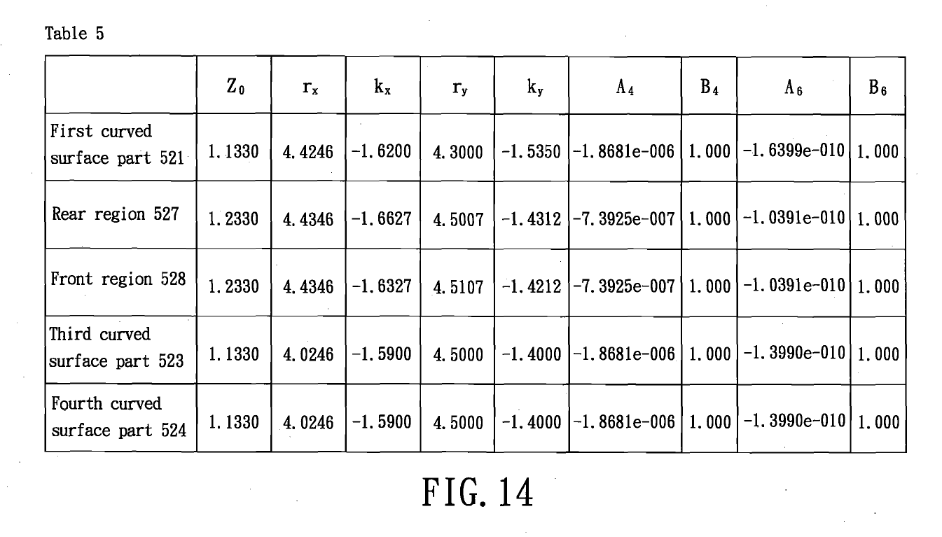

Referring to Table 5 (see FIG. 14), the front and rear regions 528, 527 of the second curved surface part 522 may also be defined by the aforementioned optical equation.

In the third preferred embodiment, the illumination intensities at measurement points “HV”, “L1”, “R1”, “2”, “3”, “L4”, “R4”, “L5”, and “R5” are 33.051 lux, 22.398 lux, 22.398 lux, 36.491 lux, 8.497 lux, 6.845 lux, 6.845 lux, 2.495 lux, and 2.495 lux, respectively. The illumination intensity in the upper horizontal region 110 is 0.953 lux. Thus, the light guide lens 50 of the third preferred embodiment of the present invention complies with the German road traffic licensing regulations, and is capable of achieving a low illumination intensity in the upper horizontal region 110 relative to the first preferred embodiment.

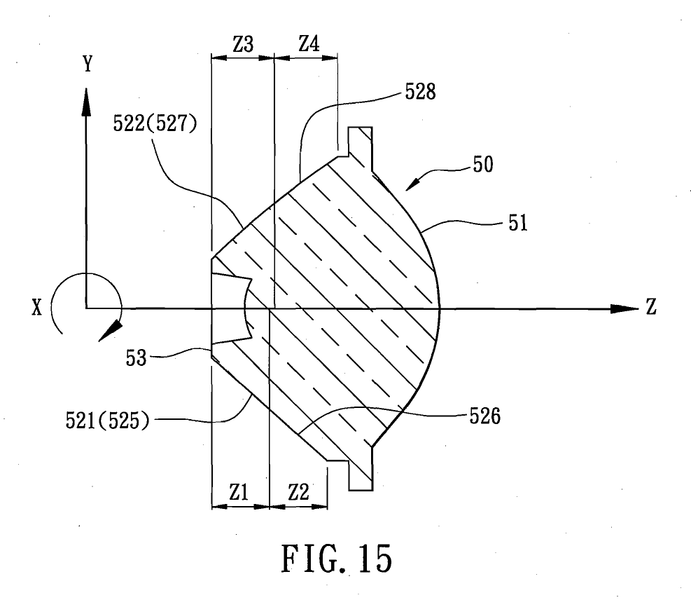

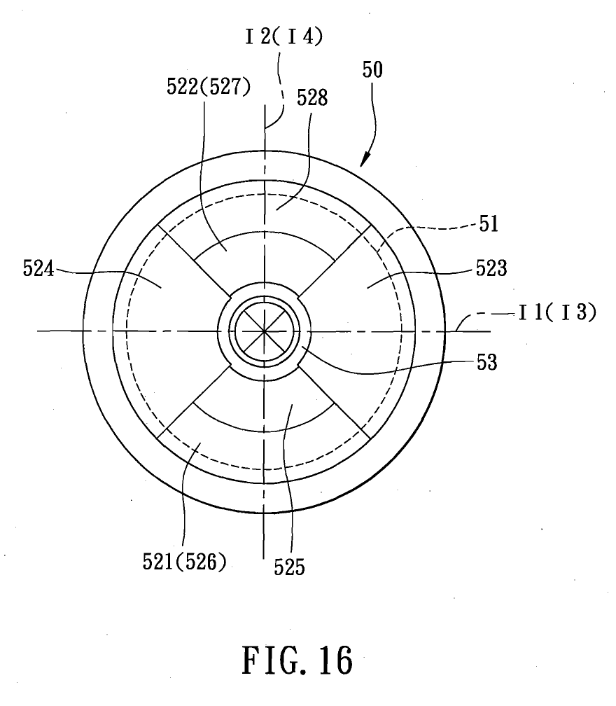

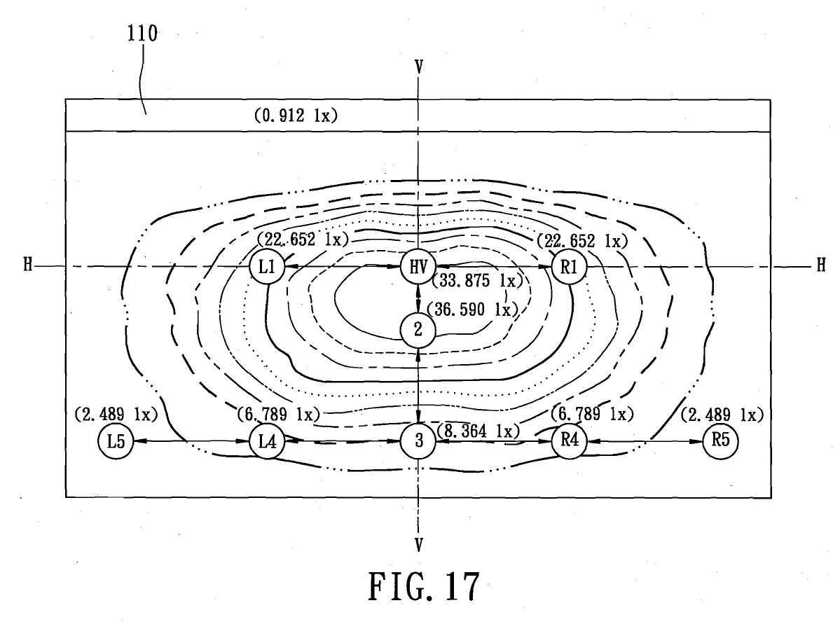

Referring to FIGS. 15 to 17, the difference between the first and fourth preferred embodiments resides in that, in the fourth preferred embodiment: the first curved surface part 521 of the outer surrounding surface 52 is divided into front and rear regions 526, 525 arranged along the optical axis (Z), and proximate to the front surface 51 and the rear end 53, respectively; and the second curved surface part 522 of the outer surrounding surface 52 is divided into front and rear regions 528, 527 arranged along the optical axis (Z), and proximate to the front surface 51 and the rear end 53, respectively. Projection of the rear region 525 of the first curved surface part 521 on the optical axis (Z) (marked by “Z1”) is identical in length to projection of the front region 526 of the first curved surface part 521 on the optical axis (Z) (marked by “Z2”). Projection of the rear region 527 of the second curved surface part 522 on the optical axis (Z) (marked by “Z3”) is identical in length to projection of the front region 528 of the second curved surface part 522 on the optical axis (Z) (marked by “Z4”).

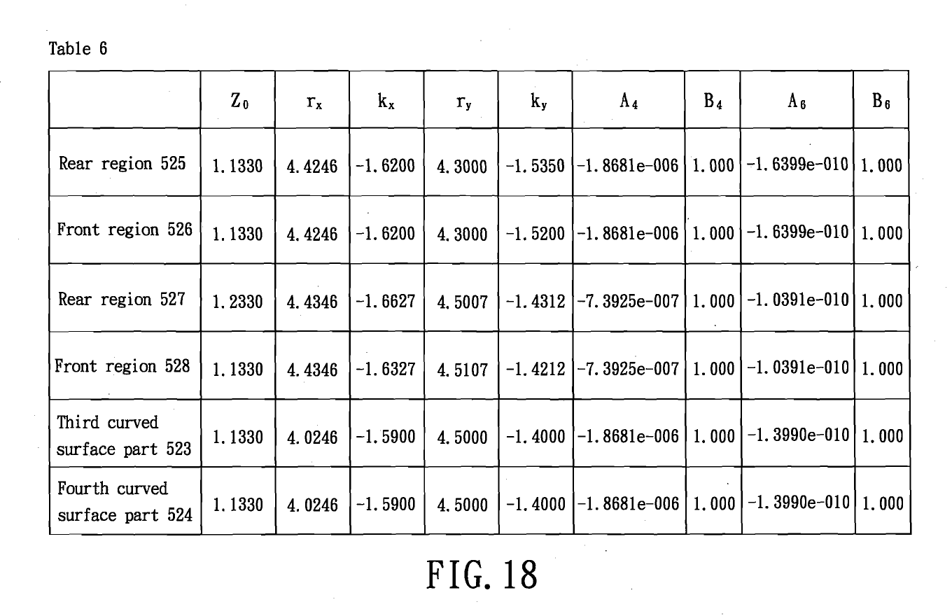

Referring to Table 6 (see FIG. 18), the front and rear regions 526, 525 of the first curved surface part 521 and the front and rear regions 528, 527 of the second curved surface part 522 may also be defined by the aforementioned optical equation.

In the fourth preferred embodiment, the illumination intensities at measurement points “HV”, “L1”, “R1”, “2”, “3”, “L4”, “R4”, “L5”, and “R5” are 33.875 lux, 22.652 lux, 22.652 lux, 36.590 lux, 8.364 lux, 6.789 lux, 6.789 lux, 2.489 lux, and 2.489 lux, respectively. The illumination intensity in the upper horizontal region 110 is 0.912 lux. Thus, the light guide lens 50 of the fourth preferred embodiment of the present invention complies with the German road traffic licensing regulations, and is capable of achieving a low illumination intensity in the upper horizontal region 110 relative to the first preferred embodiment.

By comparing FIGS. 6, 9, 13, and 17, it can be understood that the illumination intensity in the upper horizontal region 110 can be effectively reduced to thereby achieve a better light shaping effect through dividing the first and/or second curved surface parts 521, 522 into a plurality of regions. Further, it is evident that the total number of regions into which the first and second curved surface parts 521, 522 are divided is in a negative relation to the illumination intensity in the upper horizontal region 110.

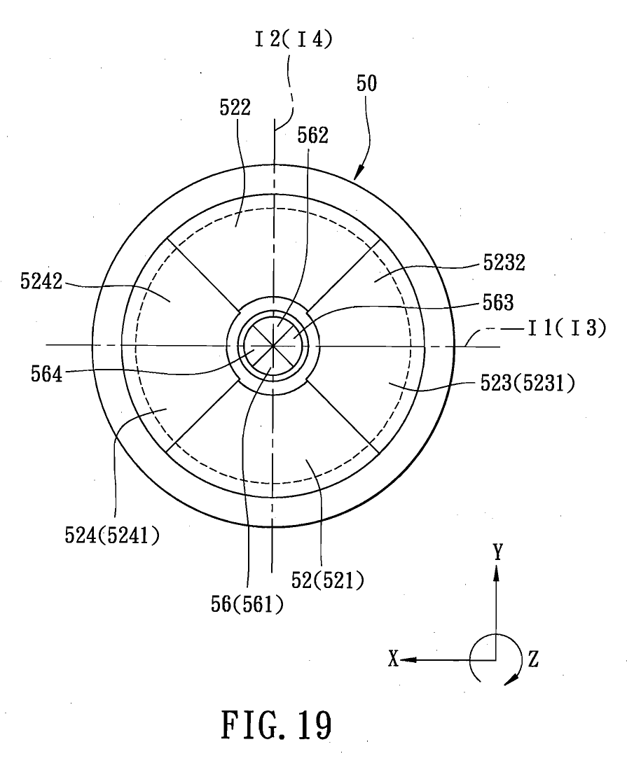

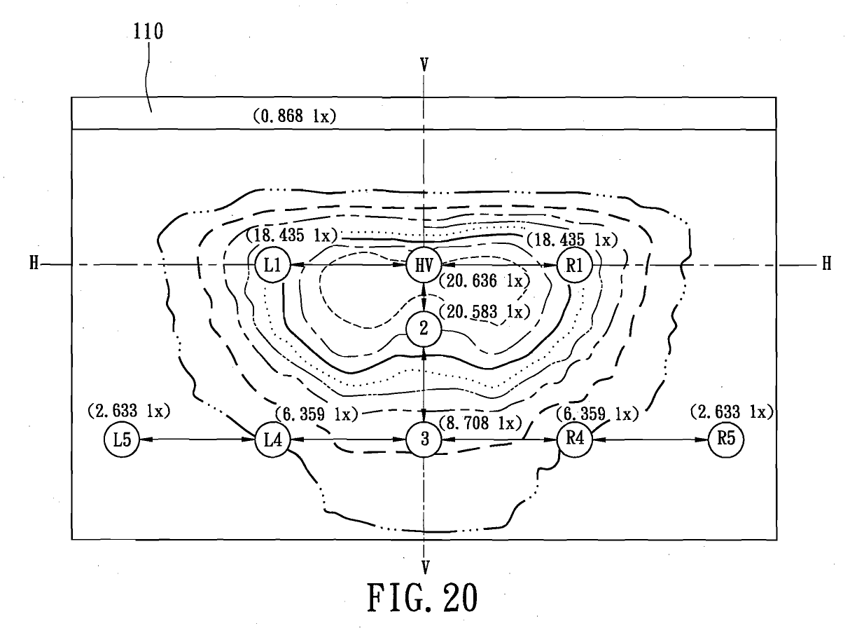

Referring to FIGS. 19 and 20, the difference between the first and fifth preferred embodiments resides in that, in the fifth preferred embodiment, each of the third and fourth curved surface parts 523, 524 has a first region 5231, 5241 and a second region 5232, 5242 arranged along a direction that is transverse to the optical axis (Z) and that is parallel to the second imaginary plane (I2), and proximate to the first curved surface part 521 and the second curved surface part 522, respectively. The first and second regions 5231, 5232 of the third curved surface part 523 are symmetrical relative to the first and second regions 5241, 5242 of the fourth curved surface part 524 with respect to the second imaginary plane (I2).

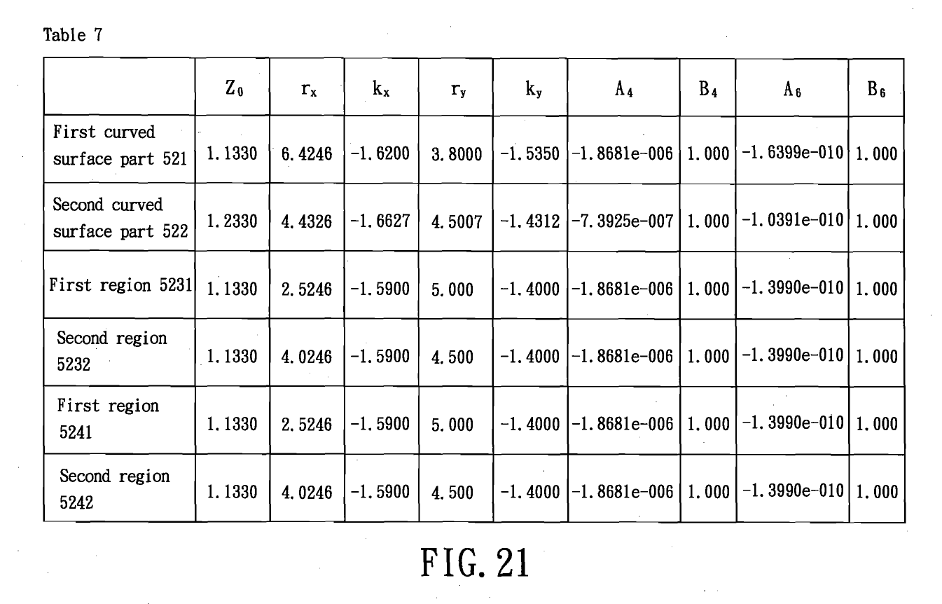

Referring to Table 7 (see FIG. 21), the first and second regions 5231, 5232 of the third curved surface part 523 and the first and second regions 5241, 5242 of the fourth curved surface part 524 may also be defined by the aforementioned optical equation.

In the fifth preferred embodiment, the illumination intensities at measurement points “HV”, “L1”, “R1”, “2”, “3”, “L4”, “R4”, “L5”, and “R5” are 20.636 lux, 18.435 lux, 18.435 lux, 20.583 lux, 8.708 lux, 6.359 lux, 6.359 lux, 2.633 lux, and 2.633 lux, respectively. The illumination intensity in the upper horizontal region 110 is 0.868 lux. Thus, the light guide lens 50 of the fifth preferred embodiment of the present invention complies with the German road traffic licensing regulations.

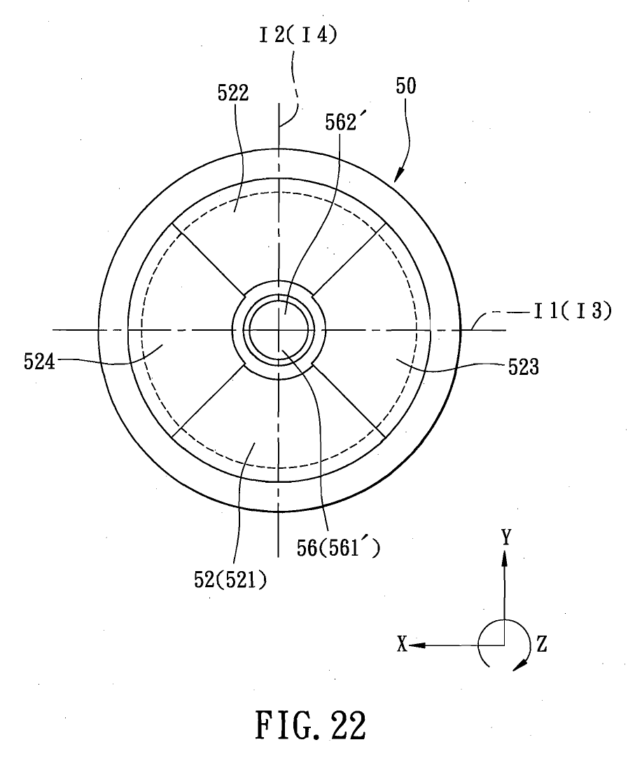

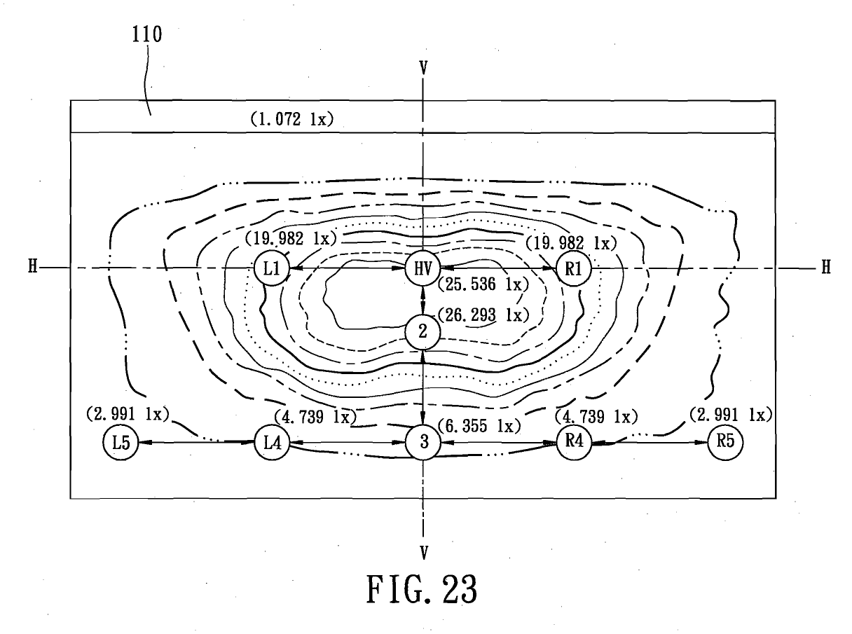

Referring to FIGS. 22 and 23, the difference between the first and sixth preferred embodiments resides in that, in the sixth preferred embodiment, the innermost surface 56 has fifth and sixth curved surface parts 561′, 562′ corresponding respectively in position to the first and second curved surface parts 521, 522, disposed respectively on the opposite sides of the third imaginary plane (I3) (i.e., the first imaginary plane (I1)), and asymmetrical relative to each other with respect to the third imaginary plane (I3).

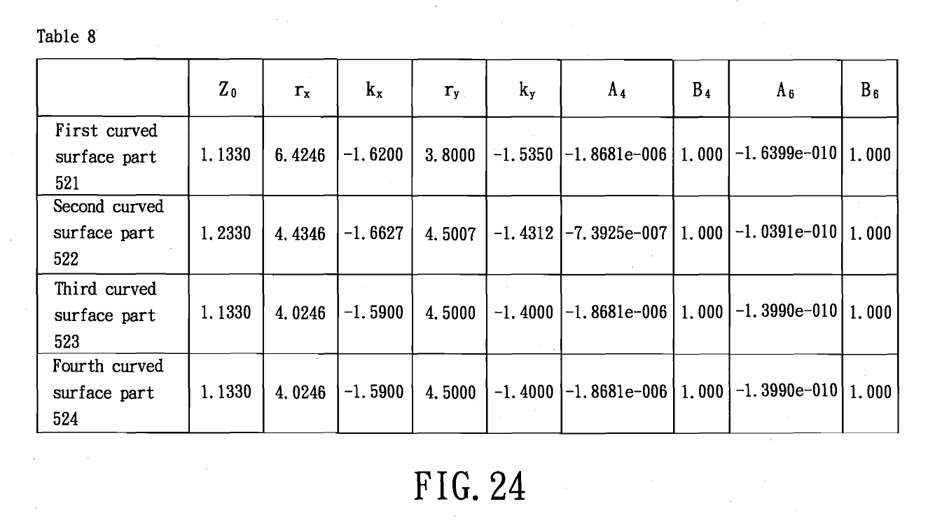

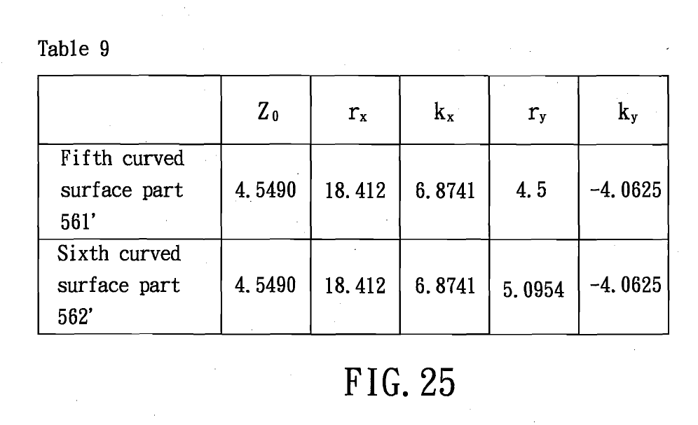

Shown in Table 8 (see FIG. 24) are values of the aforesaid parameters of the first, second, third, and fourth curved surface parts 521-524, and shown in Table 9 (see FIG. 25) are those of the fifth and sixth curved surface parts 561′, 562′ of the innermost surface 56. The fifth and sixth curved surface parts 561′, 562′ may also be defined by the aforementioned optical equation.

In the sixth preferred embodiment, the illumination intensities at measurement points “HV”, “L1”, “R1”, “2”, “3”, “L4”, “R4”, “L5”, and “R5” are 25.536 lux, 19.982 lux, 19.982 lux, 26.293 lux, 6.355 lux, 4.739 lux, 4.739 lux, 2.991 lux, and 2.991 lux, respectively. The illumination intensity in the upper horizontal region 110 is 1.072 lux. Thus, the light guide lens 50 of the sixth preferred embodiment of the present invention complies with the German road traffic licensing regulations.

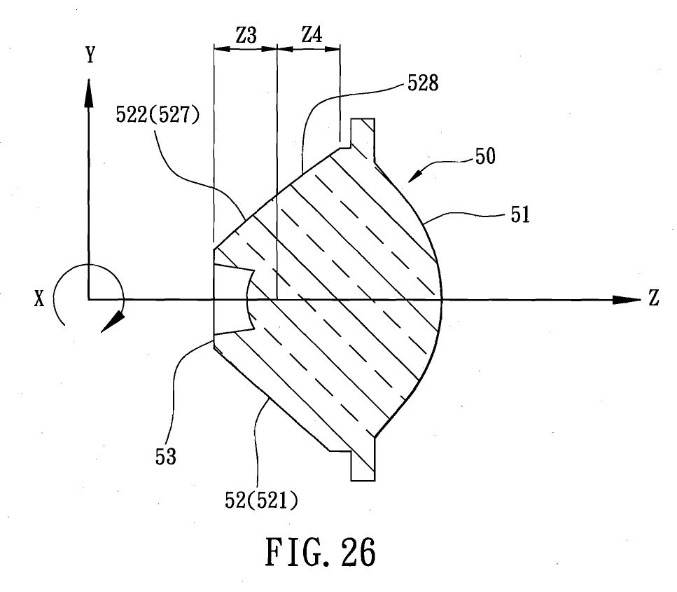

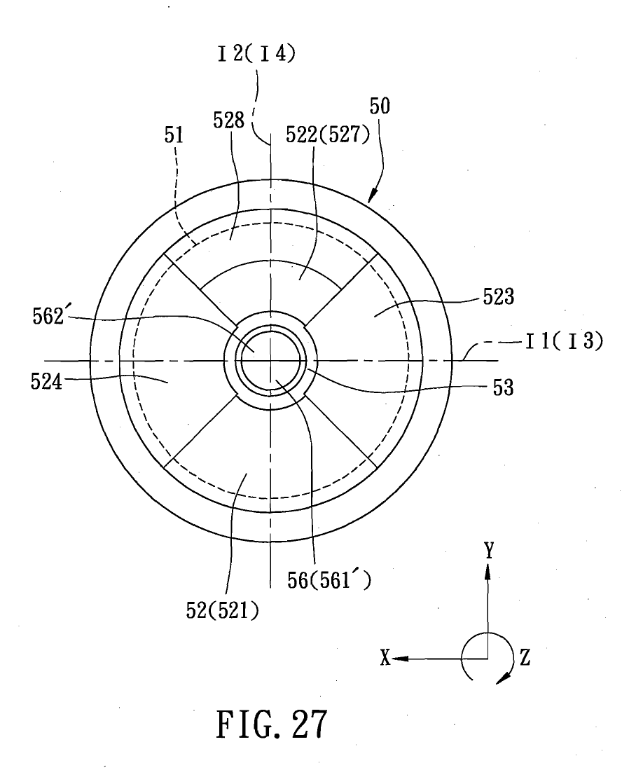

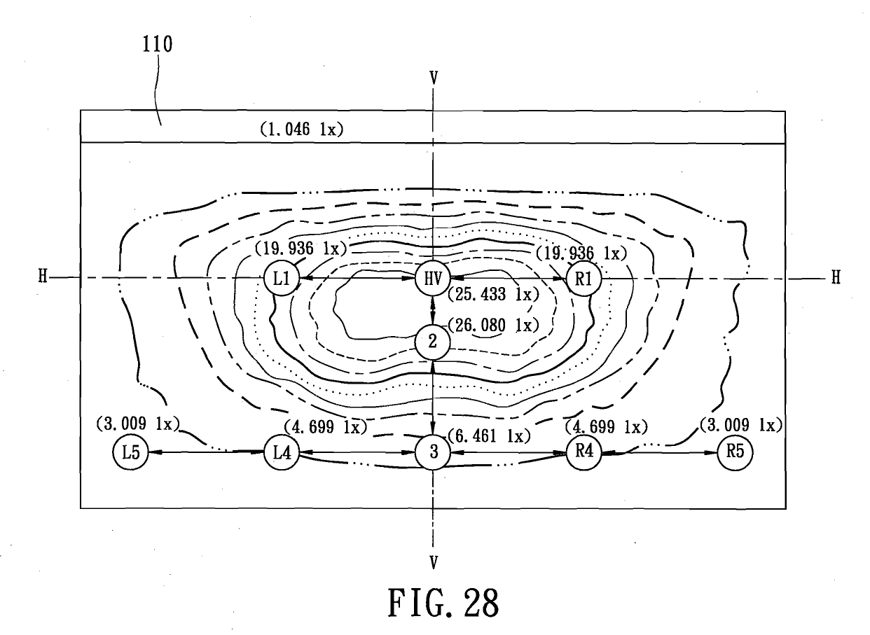

Referring to FIGS. 26 to 28, the difference between the sixth and seventh preferred embodiments resides in that, in the seventh preferred embodiment, the second curved surface part 522 of the outer surrounding surface 52 is divided into front and rear regions 528, 527 arranged along the optical axis (Z), and proximate to the front surface 51 and the rear end 53, respectively. Projection of the rear region 527 on the optical axis (Z) (marked by “Z3”) is identical in length to projection of the front region 528 on the optical axis (Z) (marked by “Z4”).

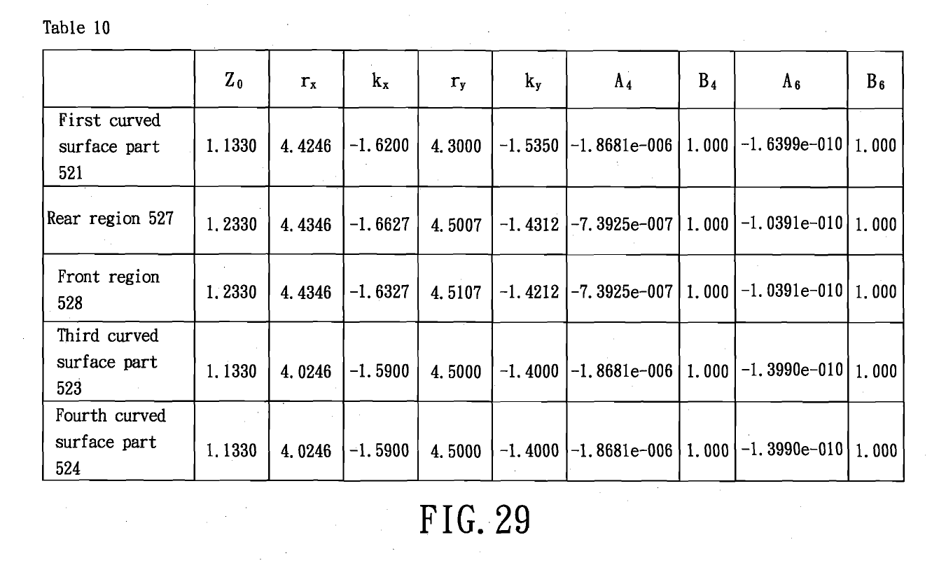

Referring to Table 10 (see FIG. 29), the front and rear regions 528, 527 of the second curved surface part 522 may also be defined by the aforementioned optical equation.

In the seventh preferred embodiment, the illumination intensities at measurement points “HV”, “L1”, “R1”, “2”, “3”, “L4”, “R4”, “L5”, and “R5” are 25.433 lux, 19.936 lux, 19.936 lux, 26.08 lux, 6.461 lux, 4.699 lux, 4.699 lux, 3.009 lux, and 3.009 lux, respectively. The illumination intensity in the upper horizontal region 110 is 1.046 lux. Thus, the light guide lens 50 of the seventh preferred embodiment of the present invention complies with the German road traffic licensing regulations.

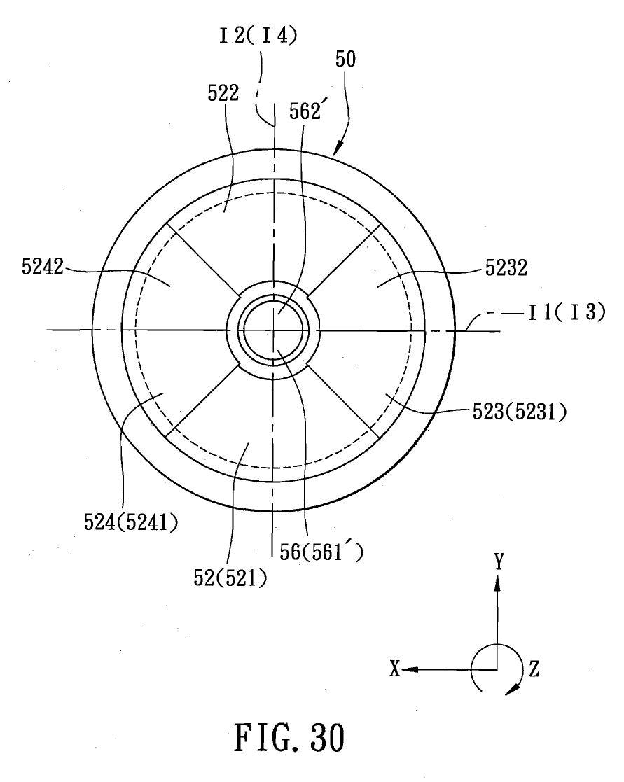

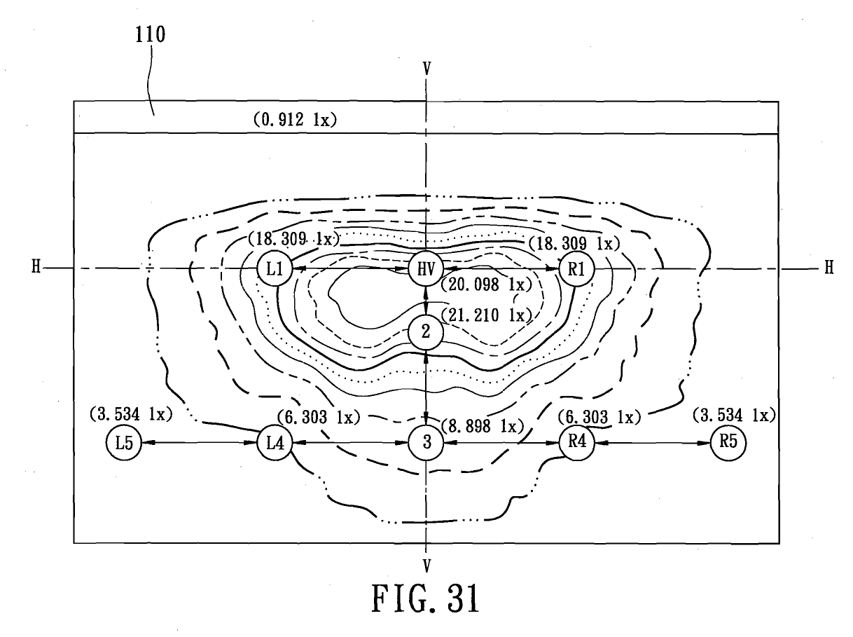

Referring to FIGS. 30 and 31, the difference between the sixth and eighth preferred embodiments resides in that, in the eighth preferred embodiment, each of the third and fourth curved surface parts 523, 524 has a first region 5231, 5241 and a second region 5232, 5242 arranged in the direction that is transverse to the optical axis (Z) and that is parallel to the second imaginary plane (I2), and proximate to the first curved surface part 521 and the second curved surface part 522, respectively. The first and second regions 5231, 5232 of the third curved face part 523 are disposed symmetrical relative to the first and second regions 5241, 5242 of the fourth curved surface part 524 with respect to the second imaginary plane (I2).

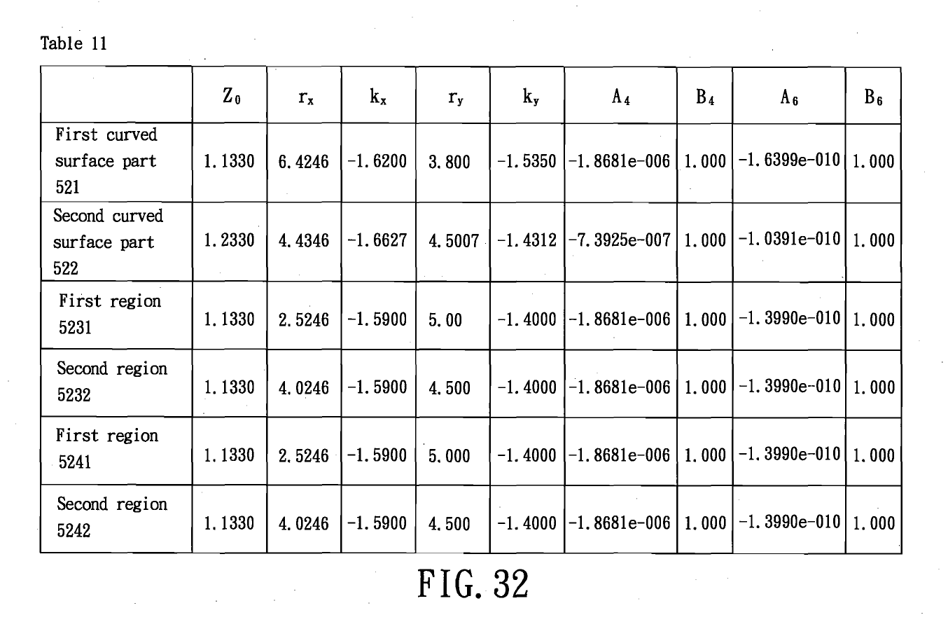

Referring to Table 11 (see FIG. 32), the first and second regions 5231, 5232 of the third curved face part 523 and the first and second regions 5241, 5242 of the fourth curved surface part 524 may also be defined by the aforementioned optical equation.

In the eighth preferred embodiment, the illumination intensities at measurement points “HV”, “L1”, “R1”, “2”, “3”, “L4”, “R4”, “L5”, and “R5” are 20.098 lux, 18.309 lux, 18.309 lux, 21.21 lux, 8.898 lux, 6.303 lux, 6.303 lux, 3.534 lux, and 3.534 lux, respectively. The illumination intensity in the upper horizontal region 110 is 0.912 lux. Thus, the light guide lens 50 of the eighth preferred embodiment of the present invention complies with the German road traffic licensing regulations.

In summary, the light guide lens 50 and the bicycle headlight having the same in each of the preferred embodiments of the present invention are capable of achieving an asymmetrical illumination distribution and a symmetrical illumination distribution with respect to the first and second imaginary planes (I1, I2), respectively.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A light guide lens comprising:
a convex front surface disposed at an optical axis;
a rear end formed with a recess that has a convex innermost surface disposed at the optical axis and an inner surrounding surface extending rearward from a periphery of said innermost surface; and
an outer surrounding surface extending between said front surface and said rear end, and diverging forwardly along the optical axis, said outer surrounding surface including
a first curved surface part and a second curved surface part disposed respectively on opposite sides of a first imaginary plane and being asymmetrical relative to each other with respect to the first imaginary plane, the optical axis being disposed on the first imaginary plane, and
a third curved surface part and a fourth curved surface part disposed respectively on opposite sides of a second imaginary plane, extending between said first curved surface part and said second curved surface part, and being symmetrical relative to each other with respect to the second imaginary plane, the optical axis being disposed on the second imaginary plane;
said convex innermost surface including a fifth curved surface part and a sixth curved surface part disposed respectively on opposite sides of a third imaginary plane and being asymmetrical relative to each other with respect to the third imaginary plane, the optical axis being disposed on the third imaginary plane.

2. The light guide lens as claimed in claim 1, wherein said innermost surface further includes a seventh curved surface part and an eighth curved surface part disposed respectively on opposite sides of a fourth imaginary plane, extending between said fifth curved surface part and said sixth curved surface part, and being symmetrical relative to each other with respect to the fourth imaginary plane, the optical axis being disposed on the fourth imaginary plane.

3. The light guide lens as claimed in claim 2, wherein said first, second, third, and fourth curved surface parts correspond to said fifth, sixth, seventh, and eighth curved surface parts, respectively.

4. The light guide lens as claimed in claim 3, wherein the first and second imaginary planes are perpendicular to each other.

5. The light guide lens as claimed in claim 4, wherein the third and fourth imaginary planes are perpendicular to each other, and coincide with the first and second imaginary planes, respectively.

6. The light guide lens as claimed in claim 1, wherein one of said third and fourth curved surface parts includes a plurality of regions arranged along a direction that is transverse to the optical axis and that is parallel to the second imaginary plane, and the other of said third and fourth curved surface parts includes a plurality of regions arranged along the direction that is transverse to the optical axis and that is parallel to the second imaginary plane.

7. The light guide lens as claimed in claim 1, wherein one of said first and second curved surface parts includes first and second regions arranged along the optical axis, projections of said first and second regions of said one of said first and second curved surface parts on the optical axis being identical in length.

8. The light guide lens as claimed in claim 7, wherein the other of said first and second curved surface parts includes first and second regions arranged along the optical axis, projections of said first and second regions of the other of said first and second curved surface parts on the optical axis being identical in length.

9. The light guide lens as claimed in claim 1, wherein said convex front surface is asymmetrical with respect to the first imaginary plane, and is further symmetrical with respect to the second imaginary plane.

10. The light guide lens as claimed in claim 1, wherein said inner surrounding surface diverges rearwardly along the optical axis.

11. The light guide lens as claimed in claim 1, further comprising an annular flange disposed at a junction of said front surface and said outer surrounding surface.

12. The light guide lens as claimed in claim 1, wherein:
light refracted by said inner surrounding surface, reflected by said first curved surface part, and refracted by said front surface forms a first light output;
light refracted by said inner surrounding surface, reflected by said second curved surface part, and refracted by said front surface forms a second light output asymmetrical relative to the first light output with respect to the first imaginary plane;
light refracted by said fifth curved surface part and said front surface forms a third light output; and
light refracted by said sixth curved surface part and said front surface forms a fourth light output asymmetrical relative to the third light output with respect to the first imaginary plane.

13. The light guide lens as claimed in claim 1, wherein:
said front surface, said outer surrounding surface, and said rear end have curvatures defined by the optical equation of
$$z - {z}_{0} = \frac{\frac{1}{{r}_{x}} {x}^{2} + \frac{1}{{r}_{y}} {y}^{2}}{1 + \sqrt{1 - \frac{( 1 + {k}_{x} )}{{r}_{x}^{2}} {x}^{2} - \frac{( 1 + {k}_{y} )}{{r}_{y}^{2}} {y}^{2 }}} + {\sum }_{n = 2}^{10} {{A}_{2 n} [ ( 1 - {B}_{2 n} ) {x}^{2} + ( 1 + {B}_{2 n} ) {y}^{2 } ]}^{n}$$
where ‘x’ represents a coordinate in an X-axis perpendicular to the optical axis, ‘y’ represents a coordinate in a Y-axis perpendicular to the optical axis and the X-axis, ‘z’ represents a coordinate in a Z-axis corresponding to the optical axis, ‘z₀’ represents a distance from the apex of the respective surface to a reference point ‘Zr’ in the Z-axis, ‘rₓ’ represents a curvature radius at the X-axis, ‘kₓ’ represents a conic constant at the X-axis, ‘r_{y}’ represents a curvature radius at the Y-axis, ‘k_{y}’ represents a conic constant at the Y-axis, ‘A₂ₙ’ represents a symmetry constant, and ‘B₂ₙ’ represents an asymmetry constant;
value of at least one of the parameters of ‘z₀’, rₓ’, ‘kₓ’, ‘r_{y}’, ‘k_{y}’, ‘A₂ₙ’, and ‘B₂ₙ’ corresponding to said first curved surface part being different from those corresponding to said second curved surface part;
value of at least one of the parameters of ‘z₀’, rₓ’, ‘kₓ’, ‘r_{y}’, ‘k_{y}’, ‘A₂ₙ’, and ‘B₂ₙ’ corresponding to said fifth curved surface part being different from those corresponding to said sixth curved surface part.

14. A bicycle headlight comprising:
a housing body;
a light guide lens disposed in said housing body, and including:
a convex front surface disposed at an optical axis,
a rear end formed with a recess that has a convex innermost surface disposed at the optical axis and an inner surrounding surface extending rearward from a periphery of said innermost surface; and
an outer surrounding surface extending between said front surface and said rear end, and diverging forwardly along the optical axis, said outer surrounding surface including
a first curved surface part and a second curved surface part disposed respectively on opposite sides of a first imaginary plane and being asymmetrical relative to each other with respect to the first imaginary plane, the optical axis being disposed on the first imaginary plane, and
a third curved surface part and a fourth curved surface part disposed respectively on opposite sides of the second imaginary plane, extending between said first curved surface part and said second curved surface part, and being symmetrical relative to each other with respect to the second imaginary plane, the optical axis being disposed on the second imaginary plane,
said innermost surface including
a fifth curved surface part and a sixth curved surface part disposed respectively on opposite sides of a third imaginary plane and being asymmetrical relative to each other with respect to the third imaginary plane, the optical axis being disposed on the third imaginary plane; and
a light source disposed in said housing body, and corresponding in position to said recess formed in said rear end.

15. The bicycle headlight as claimed in claim 14, wherein said innermost surface further includes a seventh curved surface part and an eighth curved surface part disposed respectively on opposite sides of a fourth imaginary plane, extending between said fifth curved surface part and said sixth curved surface part, and being symmetrical relative to each other with respect to the fourth imaginary plane, the optical axis being disposed on the fourth imaginary plane.

16. The bicycle headlight as claimed in claim 14, wherein said light source is a light-emitting diode (LED) lamp, said bicycle headlight further comprising a circuit board disposed in said housing body and connected electrically to said light source.
